(19) United States
(12) Patent Application Publication
(10) Pub. No.: US 2009/0320620 A1
(43) Pub. Date: Dec. 31, 2009

(54) DOOR-TYPE PASSENGER SECURITY INSPECTION APPARATUS AND METHOD FOR DETECTING CONTRABAND ARTICLES SUCH AS NARCOTIC DRUGS, EXPLOSIVES

(75) Inventors: Haifeng Hu, Beijing (CN); Zhiqiang Chen, Beijing (CN); Yuanjing Li, Beijing (CN); Jin Lin, Beijing (CN); Jinyu Zhang, Beijing (CN); Hua Peng, Beijing (CN); Qingjun Zhang, Beijing (CN); Zhongxia Zhang, Beijing (CN); Yangtian Zhang, Beijing (CN); Xiaoti Yin, Beijing (CN); Liwei Song, Beijing (CN)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: NUCTECH COMPANY LIMITED, Beijing (CN)

(21) Appl. No.: 12/483,513

(22) Filed: Jun. 12, 2009

(30) Foreign Application Priority Data
Jun. 27, 2008 (CN) 200810115774.3

(51) Int. Cl. G01N 1/14; G01N 1/10

(52) U.S. Cl. 73/863.23; 73/864.34

(57) ABSTRACT

The present invention discloses a door-type passenger security inspection apparatus comprising: an air source supplying an air flow; a spraying device for spraying the air flow onto the body and clothes of a passenger being inspected; an air-spray moving device for moving the spraying device; a collecting device for collecting suspicious particles of contraband articles separated from the body and the clothes of the passenger; and a detecting device for detecting the suspicious particles of contraband articles collected by the collecting device. Further, the present invention also provides a method for passenger security inspection on prohibited-articles. With the technical solution of the present inventions contraband articles such as narcotic drugs and explosives may be detected reliably and effectively. Thus, aiming at the requirements of anti terror, the present invention is able to ensure the security of persons and facilities at important occasions, such as airports, stations, national defenses public security, fire protection, anti-terror, customs, environmental protection, scientific research.

### FIELD OF THE INVENTION

The present invention relates to a technique of detecting contraband articles such as narcotic drugs, explosives rapidly, more particularly, to an application of a passage-type IMS, the present invention is particularly suitable for locations requiring to inspect a person whom enters, such as airports, customs, stations, national defense, public security, and important departments. More specifically, the present invention relates to a door-type passenger security inspection apparatus for detecting contraband articles such as narcotic drugs and explosives and a detection method thereof.

### BACKGROUND OF THE INVENTION

Since the terror event happened on Sep. 11, 2001 in US, anti-terror has become a significant concern all over the world. Also, terror events have happened in U.S.A., Russia, U.K., Egypt, Spain, Indonesia, India and the like. More seriously, the terror events may give rise to wars or other conflicts between nations (regions). Terrorists often start a terror attack with “human bombs”, which severely threatens the security of common people and the social stability.

Generally, security doors in the market for inspecting a person can only detect magnetic metals, and can not detect non-magnetic metals. Therefore, they can not detect explosives and narcotic drugs, which is a serious security loop-hole.

It is possible to detect suspicious particles of the narcotic drugs, explosives and the like carried by the passenger with the development of the narcotic drug/explosive detecting (IMS) technique. Recently, a great many of efforts have been made on a door-type person detecting technique using the IMS technique, and a number of patent applications, such as EP1286151A1, U.S. Pat. No. 5,915,268A1, U.S. Pat. No. 6,073,499A1 and US2001049926A1 etc. have been filed. In those patent applications, a plurality of door structures is provided to facilitate collecting particles of the inspected articles; a pre-concentration concept is employed to improve collection efficiency (for example, U.S. Pat. No. 6,073,499A1). And in order to blow down the suspicious particles carried on passenger's clothes various methods are used. Previously, a continuous airflow is blown towards the clothes of the passenger being inspected, as described in US2001049926A1; a jet head for spraying pressurized air is added later to blow the clothes, and the air is blown or sprayed in various manners, for example, the air is blown or sprayed in an upward direction or in a downward direction, as described in EP1286151A1, U.S. Pat. No. 5,915,268A1, and U.S. Pat. No. 6,073,499A1.

However, in the conventional door-type passenger security inspection apparatuses for detecting the contraband articles such as the narcotic drugs and the explosives and the detection method thereof, spraying devices for blowing down suspicious particles carried on the passenger's clothes are fixed on both sides of the inspecting door so as to blow air towards the body of the passenger from top to toe, thus, a larger amount of carrier airflow is needed. Correspondingly, the size of nozzles of the spraying devices and the size of airflow communication passages are larger. Further, the size and the power of a drive motor for driving the spraying devices are also larger. Thus, the size and manufacture cost of the spraying devices in the door-type passenger security inspection apparatus for detecting contraband articles such as narcotic drugs and explosives and the detection method thereof are increased.

In addition, in the conventional door-type passenger security inspection apparatus for detecting the contraband articles such as the narcotic drugs and the explosives and the detection method thereof, the carrier airflow in a detecting space is sucked in a sucking inlet by an air intake blower. When the sucked airflow containing the suspicious particles of the contraband articles passes through a precondensor, the suspicious particles of the contraband articles are absorbed in the precondensor. Then, during the desorbing for the precondensor, the suspicious particles of the contraband articles are released and sucked into a narcotic drug/explosive detector (IMS) to be analyzed. During the above detection process, since the absorbing and desorbing of the samples may be performed in the same work device, that is, the precondensor, in the course of continuous detection for the contraband articles such as narcotic drugs and explosives, the detection accuracy and work efficiency of the conventional door-type passenger security inspection apparatus and the detection method thereof in the detection process may be decreased.

### SUMMARY OF THE INVENTION

In view of the above, the present invention is directed to solve at least one aspect of the aforesaid problems and defects existing in the prior arts.

Accordingly, one objective of the present invention is to provide a door-type passenger security inspection apparatus for detecting contraband articles such as narcotic drugs and explosives and a detection method thereof, which can effectively reduce the size and manufacture cost of the door-type passenger security inspection apparatus and the detection method thereof.

Another objective of the present invention is to provide a door-type passenger security inspection apparatus for detecting contraband articles such as narcotic drugs and explosives and a detection method thereof, which can improve the detection accuracy and work efficiency of detecting the contraband articles such as narcotic drugs and explosives.

Still another objective of the present invention is to provide a passenger security inspection and process system for detecting contraband articles such as narcotic drugs and explosives, which can improve the detection accuracy and work efficiency of detecting the contraband articles such as narcotic drugs and explosives.

A further objective of the present invention is to provide a method for detecting contraband articles such as narcotic drugs and explosives, which can improve the detection accuracy and work efficiency of detecting the contraband articles such as narcotic drugs and explosives.

According to an aspect of the present invention, there is provided a door-type passenger security inspection apparatus, comprising: an air source supplying an airflow; a spraying device for spraying the airflow onto the body and the clothes of a passenger being inspected; an air-spray moving device for moving the spraying device; a collecting device for collecting suspicious particles of contraband articles separated from the body and the clothes of the passenger; and a detecting device for detecting the suspicious particles of contraband articles collected by the collecting device.

In one embodiment, the detecting device is an IMS analyzer.

Alternatively, the detecting device is at least one of the following: a PID photoionized detector, a MOS metal oxide sensor, an EC electrochemistry sensor.

In one embodiment, the door-type passenger security inspection apparatus further comprises an inspection passage through which the passenger being inspected enters and exits the door-type passenger security inspection apparatus.

Preferably, the door-type passenger security inspection apparatus further comprises a fan provided in the top tank which assists in spraying the suspicious particles of contraband articles separated from the body and clothes of the passenger by the spraying device into the collecting device.

In one embodiment, the air source comprises an air compressor for compressing an air; and a gas container for storing the compressed air.

Preferably, the spraying device comprises: a nozzle to direct compressed air to the body and clothes of the passenger being inspected; an air communication passage for feeding the compressed air from the air source to the nozzle; and a high speed switch valve for controlling the flowing and switching-on/switching off the airflow.

Specifically, the air-spray moving device comprises: a lifting guide rail along which the spraying device is movable; a lifting motor for driving the spraying device to move along the lifting guide rail; and a power transmission device for transmitting power of the lifting motor for driving the spraying device to the spraying device.

In one embodiment, the power transmission device transmits the power by means of a pulley cooperating with a belt or a sprocket wheel cooperating with a chain.

Specifically, the collecting device comprises: a collection passage provided at a lower side of the inspection passage, the collection passage is used to suck in and transfer the suspicious particles of contraband articles separated from the body and the clothes of the passenger; and an absorbing filter screen for absorbing the suspicious particles of contraband articles sucked in and transferred from the collection passage thereon to form detecting samples.

In one embodiment, the door-type passenger security inspection apparatus further comprises a station switching mechanism, the station switching mechanism includes: a filter screen turntable mechanism for switching the absorbing filter screen to a plurality of stations in a rotating manner; and a filter screen turntable motor for driving the filter screen turntable mechanism.

Preferably, the plurality of stations comprises: a collecting station at which the suspicious particles of contraband articles sucked in and transferred from the collection passage are absorbed onto the absorbing filter screen to form the detecting samples; a filter screen detecting station at which the detecting samples absorbed on the filter screen are detected by the detecting device; and a filter screen cleaning station at which the absorbing filter screen is cleaned by a cleaning mechanism.

Preferably, the door-type passenger security inspection apparatus further comprises a computer control system including an interactive input/output device through which the computer control system controls operations of the air source, the spraying device, the air-spray moving device, the collecting device and the detecting device.

Moreover, the door-type passenger security inspection apparatus further comprises a reporting device, wherein when the detecting device completes the detection and produces a detecting result, the reporting device reports the detecting result to a user by at least one of a visual display device and an audio alerting device.

In one embodiment, a heater is provided at the filter screen detecting station, for heating the detecting samples absorbed on the absorbing filter screen so as to gasify the detecting samples, and the gasified detecting samples are detected by the detecting device.

Alternatively, the number of the spraying device is plural, and the number of the air-spray moving device is the same as that of the spraying device.

Preferably, the number of the spraying device is two, and the two spraying devices are provided respectively at the left side and the right side of the main frame so as to blow the airflow to the body and the clothes of the passenger being inspected; and the number of the air-spray moving device is two, and the two air-spray moving devices are provided respectively in the left and right tank bodies at the left side and the right side of the inspection passage so as to move the spraying devices, respectively.

Preferably, the number of the detecting device is two, and the two detecting devices are provided respectively in the left and right tank bodies at the left side and the right side of the inspection passage so as to detect the suspicious particles of contraband articles collected by the collecting device.

Another aspect of the present invention is to provide a method for passenger security inspection on prohibited-articles, the method comprises the steps of: a spraying step for spraying an airflow onto the body and clothes of a passenger being inspected by a spraying device; a moving step for moving the spraying device in a body height direction of the passenger by an air-spray moving device while the spraying step is performed; a collecting step for collecting suspicious particles of contraband articles separated from the body and the clothes of the passenger by a collecting device; and a detecting step for detecting the collected suspicious particles of contraband articles by a detecting device.

In one embodiment, the method further comprises a guiding step for guiding the suspicious particles of contraband articles separated from the body and the clothes of the passenger into the collecting device.

Alternatively, the spraying step further comprises a step of controlling a flow rate of the sprayed air by a high speed switch valve.

Preferably, the detecting step comprises heating the detecting samples absorbed on the absorbing filter screen so as to gasify the detecting samples, and the gasified detecting samples are detected by the detecting device.

Preferably, the method further comprises a cleaning step for cleaning the absorbing filter screen after the detecting step.

Preferably, the method further comprises a step of providing a station switching mechanism in which the absorbing filter screen is switched to a plurality of stations in a rotating manner, and the collecting step, the detecting step and the cleaning step are performed at different stations.

Preferably, the method further comprises a reporting step for reporting a detecting result to a user by at least one of a visual display device and an audio alerting device after the detecting step.

In the above solutions of the present invention, a movable spraying device is employed, so the suspicious particles of contraband articles carried on the body and the clothes of the passenger may be blown down by means of a smaller amount of carrier airflow. Thus, it is possible to use a nozzle and an air communication passage with smaller sizes, therefore, the size of the whole door-type passenger security inspection apparatus may be reduced and the structure thereof is simplified. Furthermore, since the size and the power of the driving motor for driving the spraying device are correspondingly reduced, thereby, the whole size and manufacturing cost of the door-type passenger security inspection apparatus is reduced.

In addition, in the door-type passenger security inspection apparatus, the detection method thereof and the passenger security inspection and process system, a plurality of IMS detectors may be used to further improve the stability and the detection accuracy of performing a passenger security inspection.

With the above solutions, the cleaning station for cleaning the filter screen is further provided so that a cleaning and regeneration function of the filter screen may be achieved, and then the detection accuracy and the work efficiency of the door-type passenger security inspection apparatus and the detection method thereof are improved.

Thus, with the above solutions of the present invention, the contraband articles such as narcotic drugs and explosives may be detected reliably and effectively. Thus, as for the requirements of anti-terror, the present invention is able to ensure the security of persons and facilities at important occasions, such as airports, stations, national defense, public security, fire protection, anti-terror, customs, environmental protection, scientific research.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a front view of a door-type passenger security inspection apparatus according to one embodiment of the present invention;

FIG. 2 is a top view of the door-type passenger security inspection apparatus according to one embodiment of the present invention;

FIG. 3 is a right side view showing an inner structure of the door-type passenger security inspection apparatus in FIG. 2, wherein a partition wall plate 200A is removed;

FIG. 4 is a left side view showing an inner structure of the door-type passenger security inspection apparatus in FIG. 2, wherein a partition wall plate 200B is removed;

FIG. 5 is a right side section view taken along a central line of the door-type passenger security inspection apparatus in FIG. 2;

FIG. 6 is a left side section view taken along the central line of the door-type passenger security inspection apparatus in FIG. 2; and

FIG. 7 is a flowchart according to an embodiment of a method for passenger security inspection on prohibited-article.

The elements represented by the reference numerals in the attached drawings are as follows:

1—fan, 3—Ion Mobility Spectrometry detector (IMS detector), 5—lifting guide rail, 6—synchronous lifting strip for a spraying device, 7—high speed solenoid valve/rotating motor, 8—lifting motor for the spraying device, 9—filter screen heater, 10—filter screen detecting station, 11—filter screen turntable motor, 12—filter screen turntable mechanism, 13—collecting station, 14—filter screen cleaning station, 16—cleaning axial blower, 17—air compressor, 18—gas container, 19—electric appliance control panel, 20—top tank body, 21—indicting light, 22—left tank body, 23—inspection passage, 24—glass door (optional element), 25—right tank body, 27—computer system, 28—lifting guide rail, 29—synchronous lifting strip for the spraying device, 30—high speed solenoid valve/rotating motor; 31—lifting motor for the spraying device, 32—filter screen heater, 33—filter screen detecting station, 34—filter screen turntable motor, 35—filter screen turntable mechanism, 36—collecting station, 37—filter screen cleaning station, 39—cleaning axial blower, 40—centrifugal blower, 42—sensor, 43—nozzle, 44—collection passage, 47—distance measuring sensor, 48—air communication passage, 49-54—filter screen, 55—narcotic drug and explosive detector (IMS).

### DETAILED DESCRIPTION OF EMBODIMENTS OF THE INVENTION

Preferred embodiments of the present invention will be described hereinafter in detail with reference to the attached drawings, wherein the like reference numerals refer to the like elements throughout the specification. The description of the embodiments of the present invention with reference to the attached drawings is intended to explain the whole concept of the present invention, and is not intended to limit the scope of the present invention.

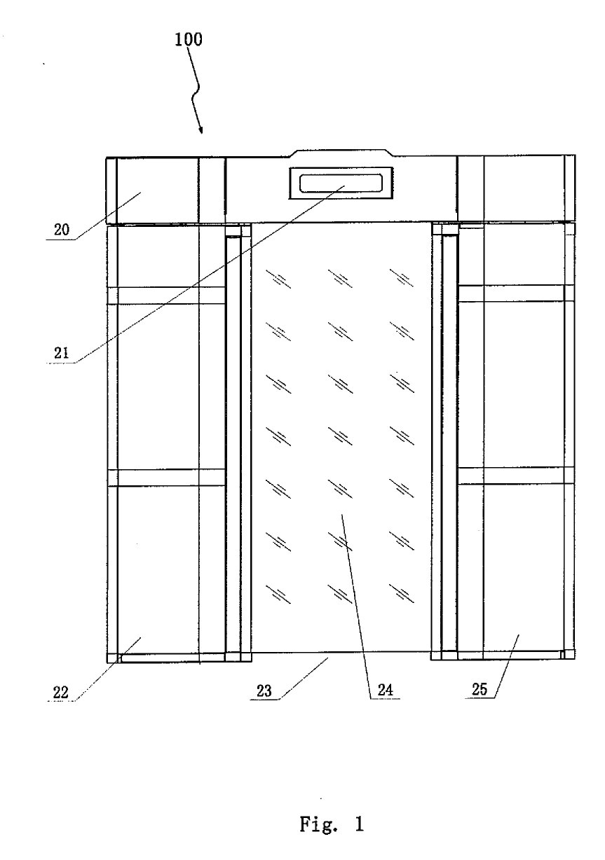

Referring to FIGS. 1-6 showing the door-type passenger security inspection apparatus 100 according to one embodiment of the present invention, the door-type passenger security inspection apparatus 100 includes: an air compressor 17 and a gas container 18 served as an air source, which is used to provide airflows; nozzles 43 used as an air spraying device, an air communication passage 48, and a high speed solenoid valve and a rotating motor thereof 7, 30 for controlling switching-on and switching off the airflows, served as a spraying device, which is used to spray the airflow onto the body and clothes of the passenger being inspected; lifting motors 18, 31 served as air-spray moving devices; lifting guide rails 5, 28; synchronous lifting strips for spraying devices 6, 29, which are used to move the spraying devices; a collection passage 44 and absorbing filter screens 49, 52 served as a collecting device, which is used in the collecting device to collect suspicious particles of contraband articles separated from the body and the clothes of the passenger being inspected; and narcotic drug and explosive detectors (IMS) 3, 55 for detecting the suspicious particles of contraband articles collected by the collecting device.

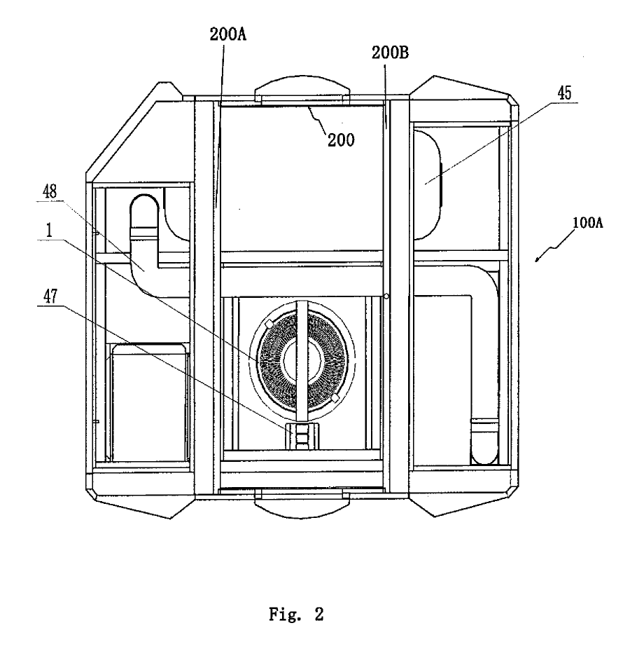

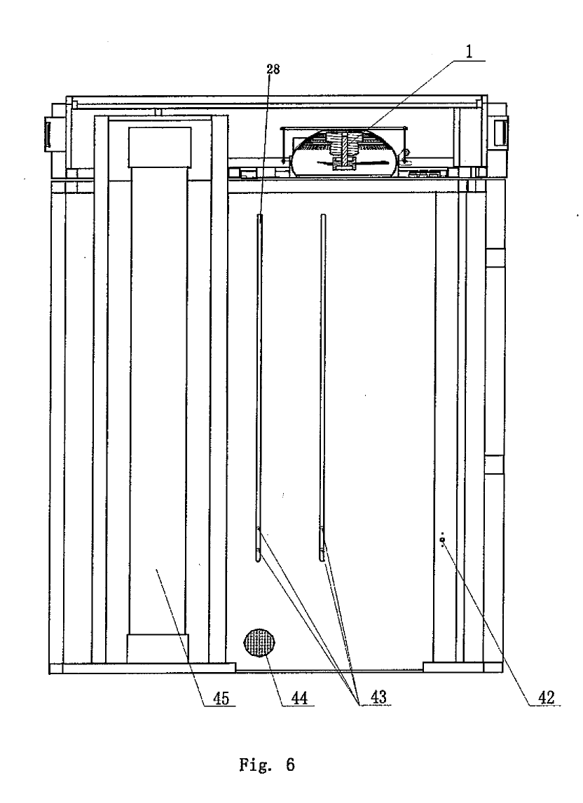

Refer to FIG. 1, which shows the appearance of the doortype passenger security inspection apparatus 100 according to one embodiment of the present invention. As shown in FIG. 2, the door-type passenger security inspection apparatus 100 comprises a main body 100A substantially having a rectangular paralleling shape. Referring to FIG. 1, the main body 100A is structured by a top tank body 20, a left tank body 22, a right tank body 25 and an inspection passage 23 provided between the left tank body 22 and the right tank body 25, and the passenger being inspected enters and exits the door-type passenger security inspection apparatus 100 through the inspection passage 23. Though in the illustrated embodiment of the present invention, the inspection passage 23 is provided between the left tank body 22 and the right tank body 25 so as to form a structure in a substantially door-shape together with the top tank body 20, the present invention is not limited to this, for example, the providing of the left tank body 22, the right tank body 25 and the top tank body 20 is not necessary, and inspection passages with any other form through which the passenger to be inspected enters and exits may also be employed. As shown in FIG. 6, sensors 42 for determining whether or not a person has entered the inspection passage 23 are provided at a suitable position in the inspection passage 23, such as a side wall. In one embodiment, all the sensors 42 are infrared proximity switches for determining whether or not a passenger has entered the inspection passage 23.

Further, referring to FIG. 2, the inspection passage 23 comprises a substantial rectangular paralleling shape formed by a main frame 200, wherein left and right partition plates 200A, 200B are respectively provided at left and right sides of the main frame 200, the left partition plate 200A separates the inspection passage 23 from the left tank body 22, and the right partition plate 200B separates the inspection passage 23 from the right tank body 25. As shown in FIGS. 1 and 2, the inspection passage 23 is further provided with glass partition plates 24 at the front side and the back side of the main frame 200, so that the inspection passage 23 is partitioned into a substantially closed or sealed space. However, the glass partition plates 24 may by replaced with other partition plates with any other suitable material. In addition, those skilled in the art may understand that the glass partition plates 24 at the front and back sides of the main frame 200 may also be removed so that an incompletely closed inspection passage 23 is formed.

Referring to FIG. 2, a fan 1 is provided in the top tank 20, the fan 1 blows downwards an airflow during the operation so as to assist in sucking the suspicious particles of contraband articles (such as narcotic drugs and explosives) separated from the body and the clothes of the passenger by the spraying device into the collection passage 44 provided at a lower end position of the inspection passage 23.

In addition, a distance measuring sensor 47 is provided at the top tank body 20, and when the passenger enters the inspection passage 23, the body height information of the passenger may be obtained by measuring a distance between the sensor 47 and a predetermined part of the body of the passenger, such as the vertex point or head portion, and referring to the predetermined distance between the sensor 47 and a bottom surface of the inspection passage 23. Obviously, the manner of obtaining the body height information of the passenger is not limited to this, and it may have various substituting forms, as long as it may obtain the body height information of the passenger effectively. A traveling range of the air-spray moving device may be determined through obtaining the body height information of the passenger by the distance measuring sensor.

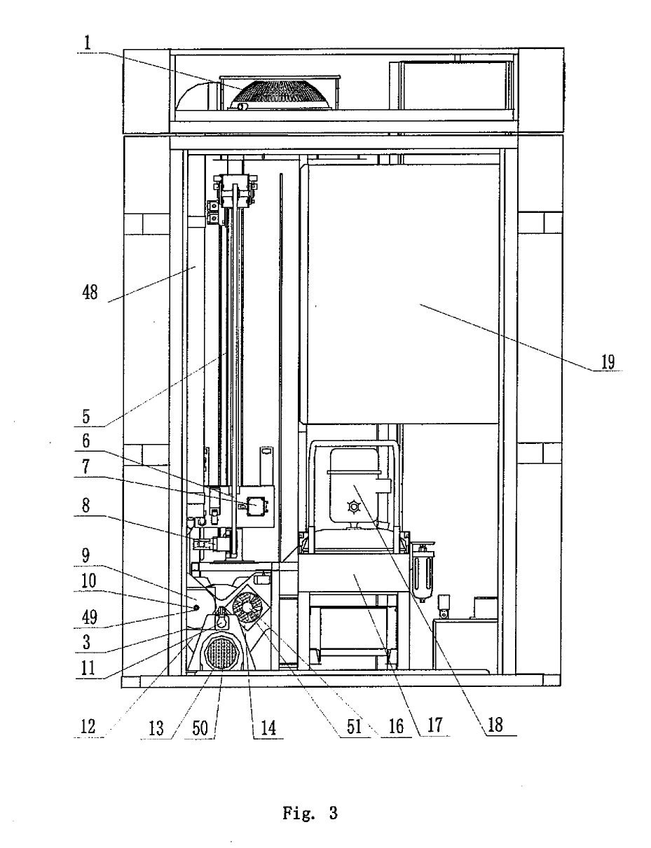

Referring to FIG. 3, the air source may comprise an air compressor 17 for compressing the air; and a gas container 18 for preferably storing the compressed air. Although the compressed air is used as the air source in the present invention, obviously, the present invention is not limited to this, and any other suitable air may also be used as the air source.

Referring to FIGS. 3-6, the spraying device comprises nozzles 43 to direct the compressed air to the body and the clothes of the passenger being inspected; an air communication passage 48 for feeding the compressed air from the air source to the nozzles 43; and a high speed switch valve, such as a solenoid valve (not shown) for controlling the flowing and switching-on and switching off of the airflow, and motors 7 and 30 preferably for driving the high speed switch valve. At the same time, the nozzles 43 are continuously moved to spray an impulsive airflow to the passenger being inspected along guide rails 5, 28, for example guide grooves, on the left tank body 22 and the right tank body 25 from top to bottom.

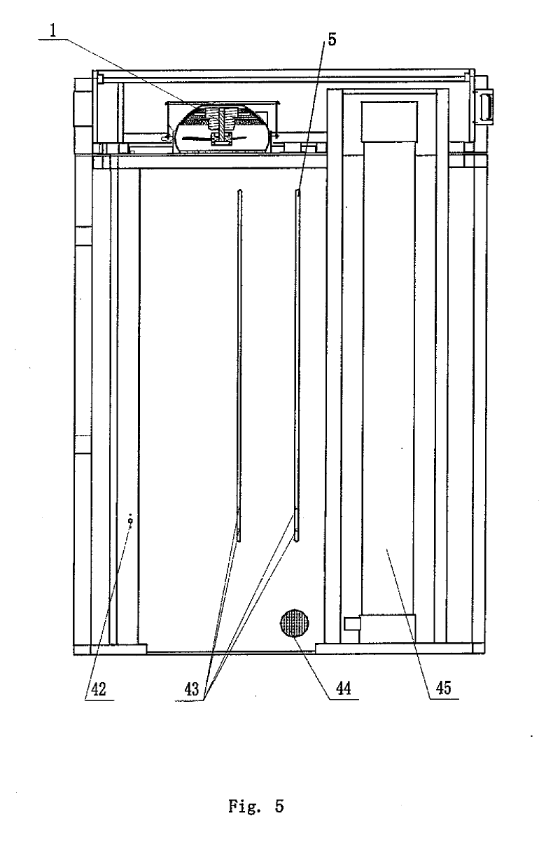

The nozzles 43 may be one or more; FIGS. 5-6 show an arrangement of nozzles that the nozzles 43 are arranged in two rows and each row comprises two nozzles 43. Obviously, the present invention is not limited thereto, and the nozzles 43 may be arranged in other suitable ways, for example, in more than two rows, for example, 3-4 rows, and each row may have more than two nozzles 43. The nozzles 43 in each group are directed towards substantially the center of the inspection passage 23 so as to improve the capability of blowing down the suspicious particles of contraband articles carried on the body and the clothes of the passenger being inspected. In one embodiment, the nozzles 43 may blow the air to the body and the clothes of the passenger being inspected in an inclined upward or downward direction.

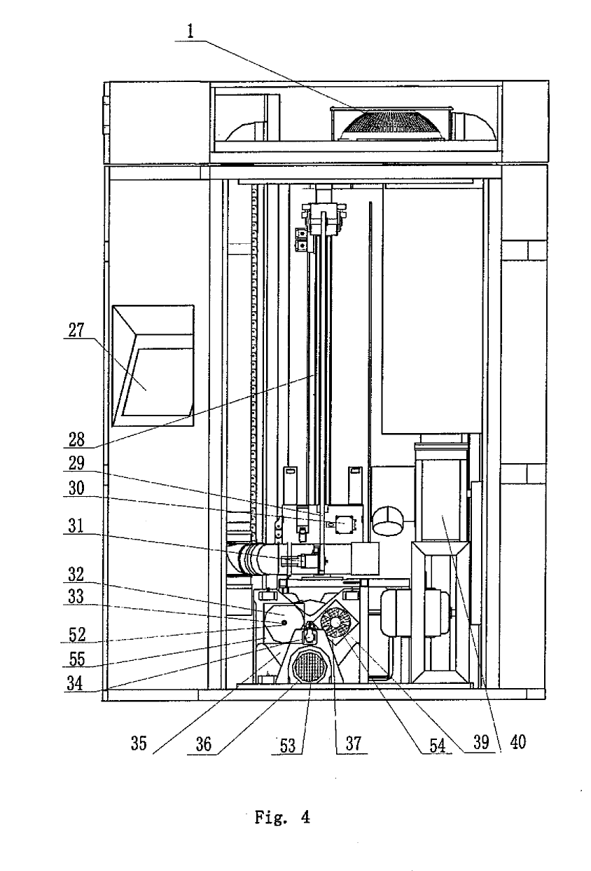

As shown in FIGS. 3-6, in one embodiment, the air-spray moving device comprises lifting guide rails 5, 28 along which the spraying device is movable; lifting motors for driving the spraying device 8, 31 to move along the lifting guide rail; and a power transmission device for transmitting power of the lifting motors for driving the spraying device 8, 31 to the spraying device. In one embodiment, as shown in FIGS. 3-4, the power transmission device transmits the power by means of a pulley cooperating with the synchronous lifting strip for spraying devices served as a belt. Those skilled in the art may understand that the present invention is not limited to this, and the power transmission device may transmit the power for example by means of a sprocket wheel cooperating with a chain, so as to transmit the power of the lifting motors for driving the spraying device 8, 31 to the spraying device.

In addition, referring to FIG. 2, in a precondition of the body height information of the passenger entered the inspection passage 23 being obtained, under the control of a computer control system 27 (which will be illustrated later), the air sprayed moving device preferably moves in a traveling range of the body height of the passenger, for example, moves from top to toe, so that the work efficiency of the spraying device is improved.

In the above solutions of the present invention, since a movable spraying device is employed, the suspicious particles of contraband articles carried on the body and the clothes of the passenger may be blown down with a smaller amount of carrier airs. Further, the nozzles and the air communication passages with smaller size may be employed, so that the structure and the size of the door-type passenger security inspection apparatus are reduced. Moreover, the size and the power of the driving motors for driving the spraying device may be reduced correspondingly, and thus, the whole size and the manufacture cost of the door-type passenger security inspection apparatus and the detection method thereof are reduced.

Referring to FIGS. 5-6, the collecting device comprises: the collection passage 44 provided at a lower side of the inspection passage 23, the collection passage 23 is used to suck in and transfer the suspicious particles of contraband articles separated from the body and the clothes of the passenger; and absorbing filter screens 50, 53 for absorbing the suspicious particles of contraband articles sucked in and transferred from the collection passage 44 thereon to form detecting samples. As shown in FIGS. 3-4, the door-type passenger security inspection apparatus 100 further comprises a station switching mechanism comprising: filter screen turntable mechanisms 12, 35 for switching the absorbing filter screens 50, 53 to a plurality of stations in a rotating manner; and filter screen turntable motors 11, 34 for driving the filter screen turntable mechanisms 12, 35. As shown in FIGS. 3-4, the filter screen turntable mechanisms 12, 35 may be switched among three stations, that is, filter screen detecting stations 10, 33, collecting stations 13, 36 and filter screen cleaning stations 14, 37, so as to perform different operations. Specifically, the filter screen turntable mechanisms may achieve switching operation among a plurality of stations through the driving of filter screen turntable motors 11, 34. The plurality of stations comprises: the collecting stations 13, 36 at which the suspicious particles of contraband articles sucked and transferred from the collection passage are absorbed onto the absorbing filter screens 50, 53 shown in FIGS. 3-4 to form the detecting samples; the filter screen detecting stations 10, 33 at which the detecting samples absorbed on the absorbing filter screens 49, 52 shown in FIGS. 3-4 are detected by the detecting device; and the filter screen cleaning stations 14, 37 at which the absorbing filter screens 51, 54 shown in FIGS. 3-4 are cleaned by a cleaning mechanism.

Referring to FIG. 4, after the spraying operation of the spraying device, a centrifugal blower 40 is started. With the function of the centrifugal blower 40, the suspicious particles of contraband articles separated from the body and the clothes of the passenger being inspected are sucked into the collection passage 44. At the collecting stations 13, 36, the suspicious particles of contraband articles in the air are absorbed onto the absorbing filter screens 50, 53 shown in FIGS. 3-4 to form the detecting samplings. The filtered air is discharged to outside by the function of the centrifugal blower 40.

Referring to FIGS. 3-4, in one embodiment, heaters 9, 32 for absorbing filter screens are provided at the filter screen detecting stations 10, 33, the heaters is used to heat the detecting samples absorbed on the absorbing filter screens 49, 52 so as to be detected by the detecting device, such as the narcotic drug and explosive detectors (IMS) 3, 55 after the detecting samples are gasified. In addition, as shown in FIGS. 3-4, axial fans 16, 39 are further provided at the filter screen cleaning stations 14, 37 to clean the absorbing filter screens 51, 54 shown in FIGS. 3-4 by blowing.

Referring to FIG. 4, the door-type passenger security inspection apparatus 100 according to the embodiment of the present invention further comprises the computer control system 27, which includes an interactive input/output device, for example a touching screen. The computer control system controls operations of the air source, the spraying device, the air-spray moving device, the collecting device and the detecting device by operating the touching screen.

In one embodiment of the present invention, the door-type passenger security inspection apparatus 100 according to the embodiment of the present invention further comprises a reporting device, wherein when the detecting device completes the detection and produces a detecting result, the reporting device reports the detecting result to a user by a visual display device, such as the indicating lights 21 Referring to FIG. 1, the indicating lights 21 are provided on the top tank body 20, for indicating the states under where the door-type passenger security inspection apparatus 100 stays, which are: an inspecting state under where a passenger being inspected and indicated by a yellow light for example; an idle state indicated by a green light; and an alarming state under where the contraband articles such as narcotic drugs and explosives are found and indicated by a red light for example. Further, as shown in FIG. 4, the detecting result produced by the detecting device may be shown to the user by a display terminal of the computer control system 27, for example the touching screen, so that the user may take a corresponding operation and process based on the state under where the door-type passenger security inspection apparatus 100 stays. Obviously, the display screen and the indicating lights served as the visual display device may be used separately or simultaneously.

However, in the present invention, the states under where the door-type passenger security inspection apparatus 100 stays may be indicated by an audio indicating device, such as a buzzer, a voice indicating device. Further, in the present invention, the states under where the door-type passenger security inspection apparatus 100 stays may be brought to the user through the audio indicating device and the visual indicating device.

In the above preferred embodiment of the present invention, the number of the spraying device is two, and the two spraying devices are provided respectively at the left side and the right side of the main frame 200 so as to blow the airflows to the body and the clothes of the passenger being inspected in an inclined and downward direction; and correspondingly, the number of the air-spray moving device is two, and the two air-spray moving devices are provided respectively in the left and right tank bodies 22, 25 at the left side and the right side of the inspection passage 23 so as to move the spraying devices respectively. Obviously, those skilled in the art may understand that the number of each of the air source, the spraying device, the air-spray moving device, the collecting device and the detecting device in the present invention may be plural or single. Based on the acting relation between the spraying device and the air-spray moving device, if the number of the spraying device is plural, the number of the air-spray moving devices is the same as that of the spraying devices.

Specifically, referring to FIGS. 3-4, the number of the detecting device is two, and the two detecting devices are provided respectively in the left and right tank bodies 22, 25 at the left side and the right side of the inspection passage 23 so as to detect the suspicious particles of contraband articles collected by the collecting device. The detection accuracy and the detection efficiency of the detecting device may be improved by providing a plurality of spraying devices or a plurality of collecting devices or a plurality of detecting devices (for example, IMS detectors).

A method for passenger security inspection on prohibited-articles by using the door-type passenger security inspection apparatus 100 according to the present invention will be described with respect to FIGS. 1-7.

When the door-type passenger security inspection apparatus 100 according to the present invention stays under the idle state, the indicating lights 21 turns on green; at this time the passenger is allowed to enter the inspection passage 23. In one embodiment, the sensor 42 detects that the passenger has entered the inspection passage 23, and reports the information that the passenger has entered the inspection passage 23 to the user, for example, the indicating lights 21 turns on yellow, which shows that the inspection apparatus 100 stays under the detecting state.

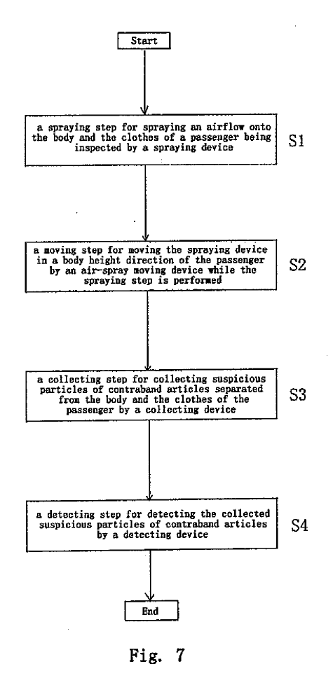

At this point, referring to FIG. 7, a spraying step S1 for spraying airflows onto the body and the clothes of the passenger being inspected by the spraying device is performed. In the embodiment of the present invention, referring to FIG. 3, the air compressor 17 is started to supply pressurized air, and the pressurized air is fed to the nozzles 43 via inlet pipes, from there, the pressurized air is blown to the body and the clothes of the passenger being inspected. Then, while the above spraying step is performed, a moving step S2 for moving the spraying device in a body height direction of the passenger by the air-spray moving device is performed. In the embodiment of the present invention, the nozzles 43 are mounted on the spraying device, the spraying device is driven up and down along the lifting guide rails 28 by the lifting motor for spraying device 31 through the synchronous lifting strip for spraying device 29, thus the nozzles 43 are moved in the body height of the passenger so as to separate the suspicious particles of contraband articles from the body and the clothes of the passenger.

In an advantageous embodiment, before performing the moving step, the information regarding the body height of the passenger entered the inspection passage 23 is obtained by the sensor 47. Accordingly, in the moving step, the air-spray moving device is driven to move the spraying device along a traveling range of the body height of the passenger, such as a range from top to toe. With the above solution, the spraying operation of the spraying device may be directed directly to the effective detecting range of the passenger being inspected, thus the amount of sprayed air and the moving distance of the air-spray moving device are reduced, so the work efficiency of the whole inspection apparatus 100 and the detection method thereof is improved.

Next, referring to FIG. 7, a collecting step S3 for collecting the suspicious particles of contraband articles separated from the body and the clothes of the passenger by the collecting device is performed. In the present invention, referring to FIGS. 2-6, the collection passage 44 is provided at the lower portions of the left tank body 22 and the right tank body 25, into which the particles are sucked by the centrifugal blower 40. The absorbing filter screens 50 and 53 collecting the particles blown down from the passenger being inspected are mounted at the end of the collection passage 44. Then, referring to FIG. 7, a detecting step S4 for detecting the collected suspicious particles of contraband articles by the detecting device is performed. In the present invention, referring to FIGS. 3-4, the particles on the absorbing filter screens 50, 53 collected in the collecting step are sucked in the narcotic drug and explosive detectors 3, 55 to be analyzed.

Referring to FIG. 2, the fan 1 is mounted at the middle of the top tank body 20, in the above spraying step, the fan 1 is driven to produce an airflow downwards, so that the suspicious particles of contraband articles separated from the body and the clothes of the passenger are guided to the collection passage 44 at the lower portion of the inspection passage 23.

In the spraying step, referring to FIGS. 3-4, the sprayed airflows in each group are controlled by the switching means, such as high speed solenoid valves/rotating motors 7, 30, so that the flow rate of the sprayed airflows are controlled by the high speed switch. With the above solutions, the suspicious particles of contraband articles may be separated effectively from the body and the clothes of the passenger, and the amount of the air is reduced.

The suspicious particles of contraband articles may be transferred to the collecting stations 13, 36 of the inspection apparatus 100 through the collection passage 44, here, the suspicious particles of contraband articles sucked in and transferred from the collection passage 44 are absorbed onto the absorbing filter screens 50, 53 to form the detecting samples. After the collection is completed, the absorbing filter screens 50, 53 are turned to the filter screen detecting stations 10, 33 to perform the detection by the filter screen turntable motors 11, 34 on the filter screen turntable mechanisms 12, 35. Preferably, the detecting samples on the absorbing filter screens 49, 52 are heated at the filter screen detecting stations 10, 33 so as to gasify the detecting samples, and the gasified detecting samples are detected by the detecting device, such as the narcotic drug and explosive detectors (IMS) 3, 55.

Preferably, as shown in FIGS. 3-4, after the detecting step is completed, the axial fans 16, 39 provided at the filter screen cleaning stations 14, 17 are driven to clean the absorbing filter screens 51, 54 shown in FIGS. 3-4 by spraying. A cleaning and regeneration function of the filter screen may be achieved by cleaning the absorbing filter screens, thus, the detection accuracy and the work efficiency of the door-type passenger security inspection apparatus and the detection method thereof are improved.

In the above method for passenger security inspection on prohibited-article, the computer control system 27 may control the lifting motor for spraying device 31, the high speed solenoid valve/the rotating motor 7, the air compressor 17, the centrifugal blower 40, the fan 1 and the like by means of an electric appliance control panel 19 served as the interactive input/output device, so as to control the spraying step, the moving step, the collecting step and the detecting step.

Referring to FIGS. 3-4, in above collecting step, the detecting step and the cleaning step, the absorbing filter screens are switched to the plurality of stations in a rotating manner, and the collecting step, the detecting step and the cleaning step are performed at different stations. With the above solutions, the detection accuracy and the work efficiency of the door-type passenger security inspection apparatus and the detection method thereof are improved because the collection and detection of the samples of the contraband articles such as the narcotic drugs and the explosives, and the cleaning of the absorbing filter screens are performed at different stations.

Later, the analyzing result of the narcotic drug and explosive detectors (IMS) 3, 55 is sent to the computer control system 27 to be processed, and is displayed on the display terminal, such as the touching screen, of the computer control system 27. if narcotic drug/explosive traces are found, an alarm is sent out while the indicating lights 21 alarm (the red light is on); if no suspicious articles are found, the current inspecting is completed, and the indicating lights 21 indicate the idle state (the green light is on) to wait for the next person to be inspected.

Though the present invention is described based on the embodiments in which the IMS analyzer is served as the detecting device, the present invention is not limited to this, and the detecting device may be at least one of the following: a PID photoionized detector, a MOS metal oxide sensor, an EC electrochemistry sensor.

Therefore, with the solutions of the present invention, contraband articles such as narcotic drugs and explosives may be detected reliably and effectively. Thus, as for the requirements of anti-terror, the present invention is able to ensure the security of persons and facilities at important occasions, such as airports, stations, national defense, public security, fire protection, anti-terror, customs, environmental protection, scientific research.

Although exemplary embodiments have been shown and described, it would be appreciated by those skilled in the art that various changes or modifications may be made in these embodiments without departing from the principles and spirit of the present invention, the scope of which is defined in the claims and their equivalents.

1. A door-type passenger security inspection apparatus, comprising:
an air source supplying an airflow;
a spraying device for spraying the airflow onto the body and clothes of a passenger being inspected;
an air-spray moving device for moving the spraying device;
a collecting device for collecting suspicious particles of contraband articles separated from the body and the clothes of the passenger; and
a detecting device for detecting the suspicious particles of contraband articles collected by the collecting device.

2. The door-type passenger security inspection apparatus according to claim 1, wherein
the detecting device is an IMS analyzer.

3. The door-type passenger security inspection apparatus according to claim 1, wherein
the detecting device is at least one of the following: a PID photoionized detector, a MOS metal oxide sensor, an EC electrochemistry sensor.

4. The door-type passenger security inspection apparatus according to claim 1, further comprising an inspection passage through which the passenger being inspected enters and exits the door-type passenger security inspection apparatus.

5. The door-type passenger security inspection apparatus according to claim 1, wherein the door-type passenger security inspection apparatus comprises a main body substantially having a rectangular paralleling shape, the main body comprising a top tank body, a left tank body, a right tank body and the inspection passage provided between the left tank body and the right tank body, and the passenger being inspected enters and exits the door-type passenger security inspection apparatus through the inspection passage.

6. The door-type passenger security inspection apparatus according to claim 5, wherein
the inspection passage comprises a main frame forming the rectangular paralleling shape, wherein left and right partition plates are respectively provided at left and right sides of the main frame, the left partition plate separates the inspection passage from the left tank body, and the right partition plate separates the inspection passage from the right tank body.

7. The door-type passenger security inspection apparatus according to claim 6, wherein
the inspection passage is further provided with glass partition plates at the front side and the back side of the main frame, so that the inspection passage is partitioned into a substantially closed space.

8. The door-type passenger security inspection apparatus according to claim 5, further comprising
a fan provided in the top tank which assists in spraying the suspicious particles of contraband articles separated from the body and the clothes of the passenger by the spraying device into the collecting device.

9. The door-type passenger security inspection apparatus according to claim 6, wherein
the air source comprises an air compressor for compressing an air; and a gas container for storing the compressed air.

10. The door-type passenger security inspection apparatus according to claim 6, wherein the spraying device comprises:
a nozzle to direct the compressed air to the body and the clothes of the passenger being inspected;
an air communication passage for feeding the compressed air from the air source to the nozzle; and
a high speed switch valve for controlling the flowing and switching-on/switching off of the airflow.

11. The door-type passenger security inspection apparatus according to claim 10, wherein the air-spray moving device comprises:
air-spray moving device lifting guide rail along which the spraying device is movable;
a lifting motor for driving the spraying device to move along the lifting guide rail; and
a power transmission device for transmitting power of the lifting motor for driving the spraying device to the spraying device.

12. The door-type passenger security inspection apparatus according to claim 11, wherein
the power transmission device transmits the power by means of a pulley cooperating with a belt or a sprocket wheel cooperating with a chain.

13. The door-type passenger security inspection apparatus according to claim 11, wherein the collecting device comprises:
a collection passage provided at a lower side of the inspection passage, the collection passage is used to suck in and transfer the suspicious particles of contraband articles separated from the body and the clothes of the passenger; and
an absorbing filter screen for absorbing the suspicious particles of contraband articles sucked in and transferred from the collection passage thereon to form detecting samples.

14. The door-type passenger security inspection apparatus according to claim 13, further comprising a station switching mechanism which comprises:
a filter screen turntable mechanism for switching the absorbing filter screen to a plurality of stations in a rotating manner; and
a filter screen turntable motor for driving the filter screen turntable mechanism.

15. The door-type passenger security inspection apparatus according to claim 14, wherein the plurality of stations comprises:
a collecting station at where the suspicious particles of contraband articles sucked in and transferred from the collection passage are absorbed onto the absorbing filter screen to form the detecting samples;
a filter screen detecting station at where the detecting samples absorbed on the filter screen are detected by the detecting device; and
a filter screen cleaning station at where the absorbing filter screen is cleaned by a cleaning mechanism.

16. The door-type passenger security inspection apparatus according to claim 1, further comprising a computer control system including an interactive input/output device through which the computer control system controls operations of the air source, the spraying device, the air-spray moving device, the collecting device and the detecting device.

17. The door-type passenger security inspection apparatus according to claim 1, further comprising a reporting device, wherein when the detecting device completes the detection and produces a detecting result, the reporting device reports the detecting result to a user by at least one of a visual display device and an audio alerting device.

18. The door-type passenger security inspection apparatus according to claim 17, wherein
the visual device comprises at least one of a display screen and a indicating light.

19. The door-type passenger security inspection apparatus according to claim 18, wherein
the audio alerting device comprises at least one of a buzzer and a voice indicating device.

20. The door-type passenger security inspection apparatus according to claim 15, wherein
a heater is provided at the filter screen detecting station, for heating the detecting samples absorbed on the absorbing filter screen so as to gasify the detecting samples, and the gasified detecting samples are detected by the detecting device.

21. The door-type passenger security inspection apparatus according to claim 15, wherein
the cleaning mechanism comprises an axial fan.

22. The door-type passenger security inspection apparatus according to claim 6, wherein
the number of the spraying device is plural, and the number of the air-spray moving device is the same as that of the spraying device.

23. The door-type passenger security inspection apparatus according to claim 22, wherein
the number of the spraying device is two, and said two spraying devices are provided respectively at the left side and the right side of the main frame so as to blow the airflow to the body and the clothes of the passenger being inspected; and
the number of the air-spray moving device is two, and said two air-spray moving devices are provided respectively in the left and right tank bodies at the left side and the right side of the inspection passage so as to move the spraying devices, respectively.

24. The door-type passenger security inspection apparatus according to claim 23, wherein
the number of the detecting device is two, and said two detecting devices are provided respectively in the left and right tank bodies at the left side and the right side of the inspection passage so as to detect the suspicious particles of contraband articles collected by the collecting device.

25. The door-type passenger security inspection apparatus according to claim 11, further comprising a sensor which is used to obtain information regarding the body height of the passenger having entered the inspection passage.

26. A method for passenger security inspection on prohibited-articles, the method comprises the steps of:
a spraying step for spraying an airflow onto the body and the clothes of a passenger being inspected by a spraying device;
a moving step for moving the spraying device in a body height direction of the passenger by an air-spray moving device while the spraying step is performed;
a collecting step for collecting suspicious particles of contraband articles separated from the body and the clothes of the passenger by a collecting device; and
a detecting step for detecting the collected suspicious particles of contraband articles by a detecting device.

27. The method for passenger security inspection on prohibited-articles according to claim 26, the method further comprises a guiding step for guiding the suspicious particles of contraband articles separated from the body and the clothes of the passenger into the collecting device.

28. The method for passenger security inspection on prohibited-articles according to claim 27, wherein
the method further comprises a step for providing an inspection passage through which the passenger being inspected enters and exits the door-type passenger security inspection apparatus; and
the guiding step comprises a step of driving a fan device provided above the inspection passage so as to guide the suspicious particles of contraband articles separated from the body and the clothes of the passenger to the collecting device located below the inspection passage.

29. The method for passenger security inspection on prohibited-articles according to claim 26, wherein the spraying step further comprises a step of control a flow rate of the sprayed air by a high speed switch valve.

30. The method for passenger security inspection on prohibited-articles according to claim 26, wherein the collecting step comprises a step of absorbing the suspicious particles of contraband articles sucked in and transferred from the collection passage onto an absorbing filter screen to form detecting samples.

31. The method for passenger security inspection on prohibited-articles according to claim 30, wherein the detecting step comprises a step of heating the detecting samples absorbed on the absorbing filter screen so as to gasify the detecting samples, and the gasified detecting samples are detected by the detecting device.

32. The method for passenger security inspection on prohibited-articles according to claim 31, the method further comprises a cleaning step for cleaning the absorbing filter screen after the detecting step.

33. The method for passenger security inspection on prohibited-articles according to claim 32, the method further comprises a step of providing a station switching mechanism in which the absorbing filter screen is switched to a plurality of stations in a rotating manner, and the collecting step, the detecting step and the cleaning step are performed at different stations.

34. The method for passenger security inspection on prohibited-articles according to claim 26, the method further comprises a control step for controlling the spraying step, the moving step, the collecting step and the detecting step through an interactive input/output device of a computer control system.

35. The method for passenger security inspection on prohibited-articles according to claim 26, the method further comprises a reporting step for reporting a detecting result to a user by at least one of a visual display device and an audio alerting device after the detecting step.

36. The method for passenger security inspection on prohibited-articles according to claim 32, wherein the cleaning step comprises a step of driving an axial fan to guide the airflow to the absorbing filter screen to clean the absorbing filter screen.

37. The method for passenger security inspection on prohibited-articles according to claim 26, wherein the method further comprises a step of obtaining information regarding the body height of the passenger having entered the inspection passage by a sensor before the moving step, and in the moving step, the air-spray moving device is driven to move the spraying device in a traveling range in respect with the body height of the passenger.

38. The method for passenger security inspection on prohibited-articles according to claim 26, wherein the detecting device is at least one of the following: an IMS analyzer, a PID photoionized detector, a MOS metal oxide sensor, an EC electrochemistry sensor.
